(19) United States
(12) Patent Application Publication
(10) Pub. No.: US 2023/0414039 A1
(43) Pub. Date: Dec. 28, 2023

(54) PERFECTER VENT

(71) Applicant: Stuart KENNETH Main, North Highlands, CA (US)

(72) Inventor: Stuart KENNETH Main, North Highlands, CA (US)

(21) Appl. No.: 17/850,954

(22) Filed: Jun. 27, 2022

(51) Int. Cl. A47J 37/12

(52) U.S. Cl. CPC A47J 37/1276; A47J 37/1271

(57) ABSTRACT

(FIGURE I) The first drawing shows the entire charcoal grill with a circle indicating the location of the next drawing. The next drawing shows a close up view of the “Perfecter Vent”. The name is intended to describe the product as an improvement on any existing grill. The opening may have to be fitted to each model grill as they all have slightly different closure angles and thicknesses. The use is the same and the effectiveness is the same on any grill. The existing vents on grills are very effective and even perfect however this tool makes ventilation even “Perfecter”. This is not a real word but it means more perfect. The ventilation is more perfect because it creates an oven effect in the hood. Greater heat is contained in the lid of the grill in addition to the more “perfecter” amount of smoke. There is such a thing as to much smokey flavor. With the perfecter ventilation tool cooking temperatures are increased on all sides in addition to containing some of the smoke. By containing some of the smoke the charcoal is allowed to breathe just enough to maintain a good cooking temperature and a good amount of smoke. Without this product people achieve this same result by constant attention and checking and adjustment. This allows the operator to monitor the temperature on the thermometer from outside the grill and not release the heat and smoke every time checking is required. Experienced grill people have made mistakes so many times that they just know how long to leave the lid on for. In combination with a thermometer grilling will improve for all. The quality of the food will improve and the consistency of the food being cooked is also improved by this product because the charcoal cannot breathe too much to flare up but just enough to create the right temperature. This product improves health by supporting safe cooking temperatures, by having perfecter control of the temperature then food can be cooked more thoroughly.

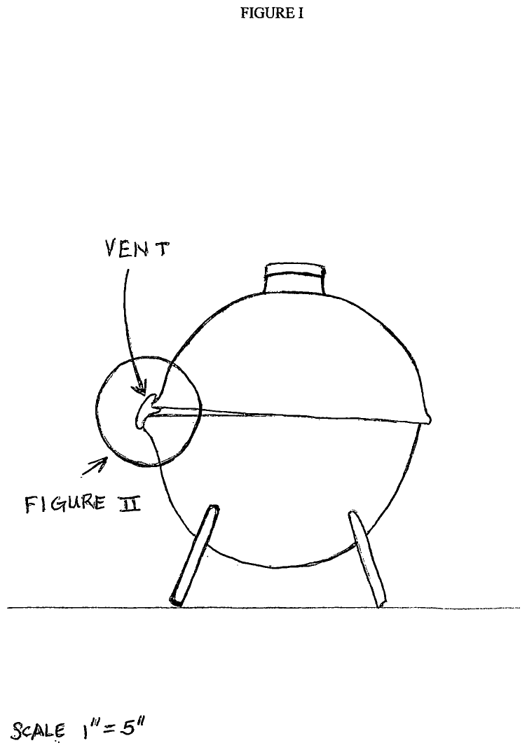

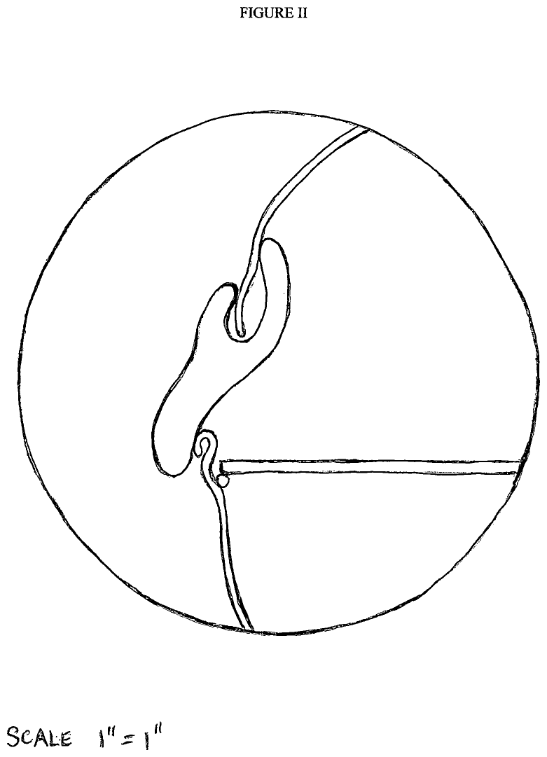

(FIGURE II) This drawing shows a close up view of the product in place. The product it self is a flat piece of metal with a shape cut out of it which is placed in between the lid and the base of a grill. The shape allows the product to hold the lid open just slightly to allow heat and smoke to collect in the lid. All vents on the lid would be closed for this to have the best effect however existing vents could be utilized to control the temperature. The shape uses the weight of the lid to maintain its position. The product prevents the lid from falling off. The product does get hot however it can be lifted with a utensil such as tongs. It can be removed or placed with tongs or a handle may be developed later. It can be held temporarily without causing injury. It can be released prior to causing a burn to the hands. It may stay attached to the lid long enough to be shaken off it a controlled location that would not cause any melting or injury. The second drawing is to scale and actual size. The product is the shape in the center of the drawing separating the lid from the base of the grill. Food grade metal would be used in the production although it is not intended to make contact with food.

### SPECIFICATION

The “PERFECTER VENT” is constructed of ⅛ inch of plate steel. Food grade metal would be used in the production however there should not be contact with food being prepared. Contact may accidentally occur and there would not be any toxic coatings applied as they may contaminate food. A shape is cut out of the plate steel that locks onto the lid of a charcoal grill and anchors the lid in position. The position allows the lid to be opened slightly and provide ventilation to the charcoal and grill. This position is fixed by the product which is attached to the lid. The weight of the lid creates the locking pressure which holds the product in place. With the product in place the lid can be rest slightly open without falling off. The shape cut into one end allows the product to lock onto the lid. The shape cut into the other side of the product creates the optimal ventilation and provides an anchor to prevent the lid from falling. The weight of the lid creates the torque which locks the product onto the lid. Once the lid is lifted the product will release from the lid. Heat from the cooking process makes the product hot to the touch however injury does not usually occur. Reasonable caution should be taken when handling the product at operating temperature. The operator can release the product if it is accidentally picked up at temperature, without sustaining injury. The frequency of accessing the grill is reduced because of the temperature control of the product. The product can be manipulated with pliers or any other heat resistant tongs or similar tool. A rag would not be the recommended method of manipulating the product due to proximity to the grill itself. The dimensions are approximately two inches long and one inch wide. It is roughly in the shape of a capitol Y. The top of the lid is first inserted into the top of the Y and the lower part of the Y is placed outside the grill base and positioned such that the weight of the lid holds the “PERFECTER VENT” in place. The lid is then held open as a result allowing the optimal amount of ventilation and containing heat in smoke inside the lid rather than releasing it.

### SUMMARY

The “PERFECTER VENT” improves the quality of life for the operator by improving the cooking process on a charcoal grill. The quality of the cooking process is improved in several ways. This product makes fool proof the practice of leaving the lid balancing slightly open. Often the grill operator will develop an amount of residue build up on the lid and grill base which allows the lid to balance. The lid often still falls of and does not find a consistent ventilation position. This tool does not require the build up of residue in order to maintain the balanced lid position. Furthermore the lid is in a consistent and optimal position. The grill can be sanitized without eliminating the function of balancing the lid partially open. Anchoring the lid at the optimal position allows for improved consistency of heat and therefore reduces the variables involved in the cooking process. The intended process is to close any lid ventilation that is part of the original design and to use the lid to capture heat and smoke within the grill. By capturing heat and smoke the food is brought to temperature on all sides. This eliminates burning and over cooking by increasing the internal temperature of the food. Normally food is primarily cooked by direct heat from the charcoal. The lid has an adjustable vent on the top of the lid. The original design of these charcoal grills allows significant heat to escape out the top and reduce the cooking effectiveness. By creating the vent on the side the cooking process is significantly improved. The vent on top could additionally be utilized as an option to the grill operator in some applications. A thermometer on the lid would be a beneficial addition to improve control of the cooking process. The side ventilation does create a flow which has reduced “flare ups” because of the smoke and amount of ventilation. By providing the perfect amount of ventilation the result is greater controlled burn of the charcoal and more efficiency and quality by containing heat in the lid.

### History

There is no product available that provides the use and intent as this product. Primarily it is common knowledge and standard usage to allow the lid of the grill to rest slightly open. To allow the lid to rest with a small amount of ventilation is common sense however this too removes several problems associated with this technique. One problem with this technique is that the lid falls off. This tool allows ventilation while securing the lid from falling off. A second problem with the method of letting the lid balance slightly open is that the opening is different every time. This tool ensures the perfect amount of ventilation which creates the perfect conditions for cooking. The optimum opening allows for enough air to the charcoal while not letting too much heat out of the grill. This creates a partial smoking chamber or oven condition rather than only utilizing the direct heat of the charcoal. The result is improved quality of cooking because the lid vents are intended to be closed and capture heat and smoke which both cooks the food in addition to providing flavor from the smoke. Furthermore a problem with a different type of ventilation system is that the amount of air allows for excessive heat to build up. This tool is designed to provide an amount of ventilation that reduces the oxygen enough to prevent excessive heat conditions. The “PERFECTER VENT” builds upon normal common place charcoal grill equipment and optimizes the ventilation to improve the quality of cooking temperature and flavor. There is nothing on the market that does this and there has never before been anything that does what this tool does.

### DRAWING DESCRIPTION FOR FIG. I

FIG. I depicts the tool “PERFECTER VENT” at a one inch equals five inches scale in position on a charcoal grill. This drawing shows the approximate amount this tool holds the lid open. This tool is used on any charcoal grill. The intent is to create the perfect air flow for cooking. All other original vents are intended to be closed however they could be used as an option in some applications. The right amount of heat can be estimated by the amount of smoke emanating from the ventilation opening. A thermometer could be used to further improve temperature control. By closing vents on the lid heat is allowed to collect with the right amount of smoke which cooks the food better and adds flavor to the food.

FIG. II is indicated on this drawing which provides a close up view at a one to one scale.

### DRAWING DESCRIPTION FOR FIG. II

This drawing is a close up of the tool and its position on the grill. This close up is at a one to one scale. The location of the drawing is indicated on the prior drawing which is at one inch equals five inches scale. The grill is approximately 15 inches in diameter. The weight of the lid is what maintains the position of the “PERFECTER VENT”. The open end of the tool is anchored to the top lid and the torque created by the bottom half rotating the tool against the lid keeps it in place. The drawing indicates contact points of the tool on the lid. Common sense tells us that the lid will tend to fall off the opposite end as it is being opened. The friction of the contact surface of the lid to the lower half is insufficient to reliable hold the lid partially open. In addition, balancing the lid results in different size of vent every time. This product emulates balancing the lid partially open. This product provides reliability and optimal ventilation to the grill operator by maintaining the position depicted in FIG. II.

1. This tool builds on common charcoal grill equipment and optimizes the ventilation to improve the temperature and flavor of food. This product solves several problems for the grill operator which includes providing consistent temperature and reducing excessive heating conditions by optimizing the ventilation. By creating the perfect size opening holding the lid in just the right position heat is retained as well as smoke while providing enough oxygen to the charcoal yet not too much. Once smoke builds up the amount of smoke leaving the grill can be estimated to determine that the charcoal is remaining hot. By not providing excessive ventilation the temperature remains consistent and improves the quality and prevents waste. By providing consistent temperature this allows the operator to better estimate cooking time and learn the desired amount of cook time. This tool removes variation in the ventilation and simplifies the cooking process to allow for greater control and learning. This tool allows for greater learning by isolating the factors of the cooking process and helps control the burning of the charcoal. The operator can manipulate other factors such as the amount of charcoal or food on the grill in order to determine the optimal amount of cooking time. As a result of this product more food will be prepared to safe temperatures and improve the health of the consumer and reduce waste.
